(19) United States
(12) Patent Application Publication
(10) Pub. No.: US 2009/0138691 A1
(43) Pub. Date: May 28, 2009

(54) Method, system and computer-readable medium for personalized computational device configuration

(76) Inventor: Harold Lee Peterson, Scotts Valley, CA (US)

Correspondence Address: PATRICK REILLY, P.O. BOX 7218, SANTA CRUZ, CA, 95061-7218, US

(21) Appl. No.: 11/986,964

(22) Filed: Nov. 27, 2007

(51) Int. Cl. G06F 9/00

(52) U.S. Cl. 713/1

(57) ABSTRACT

A system and method for providing information concerning software, products and services in a consumer's out-of-the-box experience with a newly purchased computational device are provided.

### FIELD OF THE INVENTION

The present invention relates to the computational services and software. The present invention more particularly relates to enabling access to computational services and software.

### BACKGROUND OF THE INVENTION

Manufacturers and marketers of computational devices such as personal computers, personal digital assistants, and digital cellular telephones, often include software products and offers to purchase software products, service and goods in the electronic memories of their products. This inclusion of software products and offers to purchase software products, services and goods can be a significant source of revenue to many sellers of consumer electronic devices. Yet consumers can be annoyed when their initial experience with a newly purchased device, referred to as the out-of-the-box experience, is cluttered or complicated by multiple offers to use or purchase software, products or services. This annoyance of the consumer can be counter productive and reduce the effectiveness of presenting a consumer with additional purchasing opportunities within an out-of-the-box experience. This reduction in marketing effectiveness can lower the amount of revenue that a manufacturer or marketer of a computational device might receive from third party providers that will pay to have information concerning their third party products and services included in the configuration of the computational device as delivered to a consumer.

The prior art includes efforts to improve the out-of-the-box experience of the consumer. U.S. Pat. No. 7,222,106 (Block, et al., May 22, 2007) discloses mechanisms for handling software license agreements on a multi-user system; U.S. Pat. No. 6,823,508 (Burkhardt, et al., Nov. 23, 2004) presents an automatic computer program customization based on a user information store; U.S. Pat. No. 7,062,645 (Kroening, Jun. 13, 2006) describes a “build to order” personal computer manufacturing fast boot method; U.S. Pat. No. 6,345,294 (O'Toole, et al., Feb. 5, 2002) discloses methods and apparatus for remote configuration of an appliance on a network; and U.S. Pat. No. 6,757,723 (O'Toole, et al., Jun. 29, 2004) also discloses methods and apparatus for remote configuration of an appliance on a network.

Each and every patent and patent application mentioned in the present disclosure, to include U.S. Pat. Nos. 7,222,106; 6,823,508; 7,062,645; 6,345,294; and 6,757,723, are hereby incorporated by reference in their entirety and for all purposes.

Yet the prior art fails to optimally offer information concerning products and services to a consumer in an out-of-the-box experience, also referred to as “out of box experience” in the prior and related art. There is therefore a long felt need to improve the effectiveness of offering products and services, and offers for purchase thereof, in a consumer's out-of-the-box experience with a newly purchased computational device.

### SUMMARY OF THE INVENTION

Towards this object and other objects that will be made obvious in light of this disclosure, a first version of the method of the present invention provides a method and system for providing information concerning software, products and services in a consumer's out-of-the-box experience with a newly purchased computational device.

In a first alternate preferred embodiment of the method of the present invention, a consumer is presented by means of a purchased computational device (hereafter, “computer”) with opportunities to learn about, use or purchase software, software enabled services, and/or goods, to include computer hardware, communications services, Internet service provider services, information security software, one or more warranties covering the host computer, and one or more applications programs. The one or more applications programs may include an email client, an address book, a computer security program, a web browser, a word processing program, a spreadsheet program, a software database, a software database management system, a graphics generation program, a video player, a video data editor, an audio data editor, and a calendar software.

A second alternate preferred embodiment of the method of the present invention provides a directory of profiles, wherein each profile includes a unique plurality of indications of applications software that may be of interest to certain types of purchasers or users of computers. For example, a profile identified as a STUDENT profile may include indications of software and/or Internet services that are made available to students at reduced pricing. In another example, a profile identified as a PROFESSIONAL profile may contain indications of software and/or Internet services that have premium capabilities and higher prices than student versions and services. In yet another example, an ESPANOL profile may include indications of software and/or Internet services that are localized for the convenience of Spanish language speakers and writers.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 is a process chart of a business method in accordance with certain aspects of the method of the present invention;

FIG. 2 is a block diagram illustrating an exemplary computer in accordance with certain preferred embodiments of the present invention;

FIG. 3 is a software flowchart of a process whereby the computer of FIGS. 2, 7 and 8 may implement certain aspects of the first alternate preferred embodiment of the method of the present invention;

FIG. 4 is a software flowchart of a process whereby the computer of FIG. 2 may implement certain other aspects of the first alternate preferred embodiment of the method of the present invention;

FIG. 5 is a software flowchart of a process whereby the computer of FIGS. 2, 7 and 8 may implement certain yet other aspects of the first alternate preferred embodiment of the method of the present invention;

Referring now generally to the Figures and particularly to FIGS. 6A and 6B, FIGS. 6A and 6B are software flowcharts of a process whereby the computer of FIGS. 2, 7 and 8 and the electronic communications network of FIG. 8 may implement certain yet other aspects of the second alternate preferred embodiment of the method of the present invention.

FIG. 7 is a block diagram of the computer of FIG. 2 with illustrations of additional aspects;

FIG. 8 is a block diagram of an electronics communications network by which the second alternate preferred embodiment of the method of the present invention may be implemented;

FIG. 9 is a software flowchart of still other aspects of certain preferred alternate embodiments of the method of the present invention;

FIG. 10 is a schematic diagram of the directory of FIG. 1;

FIG. 11 is a schematic diagram of a record database of FIG. 2;

FIG. 12 is a block diagram of the config application program of FIGS. 1, 2 and 7;

FIG. 13 is a directory menu from which a user may select a profile;

FIG. 14 is a purchase selection menu from which a plurality of products may be individually selected and purchased;

FIG. 15 is a credit information menu with which a user may provide credit account information to the computer of FIGS. 2 and 7;

FIG. 16 is a shipping information menu with which a user may provide product mailing or other delivery instructions to the computer of FIGS. 2 and 7;

FIG. 17 is a software flowchart of the computer of FIG. 2 and executing still additional aspects of certain preferred alternate embodiments of the method of the present invention 7 in coordination with the server and the network of FIG. 2;

FIG. 18 is a schematic diagram of four records of FIG. 11 that are referenced by a third profile, or “gamer profile” of FIG. 10; and

FIG. 19 is an illustration of a visual rendering of the gamer profile of Fig. in a selection menu by the display device of the computer of FIGS. 2 and 7.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result. Moreover, those skilled in the art will appreciate that various embodiments of the invention may be practiced with other computer system configurations, including hand-held devices, gaming consoles, multiprocessor systems, microprocessor-based or programmable consumer electronics, network personal computers, minicomputers, mainframe computers, and the like. In a distributed computer environment, software programs may be located in both local and remote memory storage devices. Alternatively, embodiments of the invention can be implemented in hardware or a combination of hardware, software, and/or firmware. For example, at least part of the invention could be implemented in one or more application specific integrated circuits and/or one or more programmable logic devices.

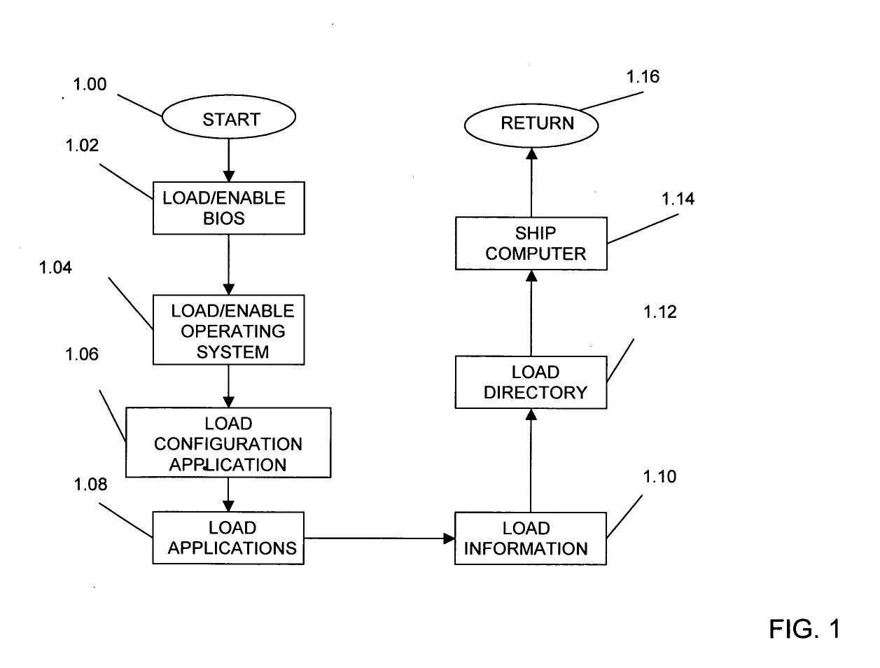

Referring now generally to the Figures and particularly to FIG. 1, FIG. 1 is a process chart of a software build of a computer 2 in accordance with certain aspects of the method of the present invention. In step 1.00 the computer 2 is powered up and in step 1.02 a basic input output system 4 (hereafter, “BIOS” 4) is enabled or loaded and enabled. An operating system 6 (hereafter, “op sys” 6 is then loaded into the computer in step 1.04 and a configuration software application 8 (hereafter, “config app” 8 is loaded into the computer 2 in step 1.06. A plurality software applications 10.A-10.N (hereafter “apps” 10.A-10.N) are loaded into computer 2 in step 1.08 and a plurality of product and service information items 12.A-12.N (hereafter, “info” 12.A012.N) are also loaded into the computer 2 in step 1.10. A software directory 14 containing a plurality of organized and formatted user profiles 16.A-16.N are loaded into the computer 2 in step 1.12. The computer 2 is shipped as a consumer electronics product in step 1.16 to either directly to a consumer or purchaser, to a retailer or wholesaler, or otherwise into the stream of commerce.

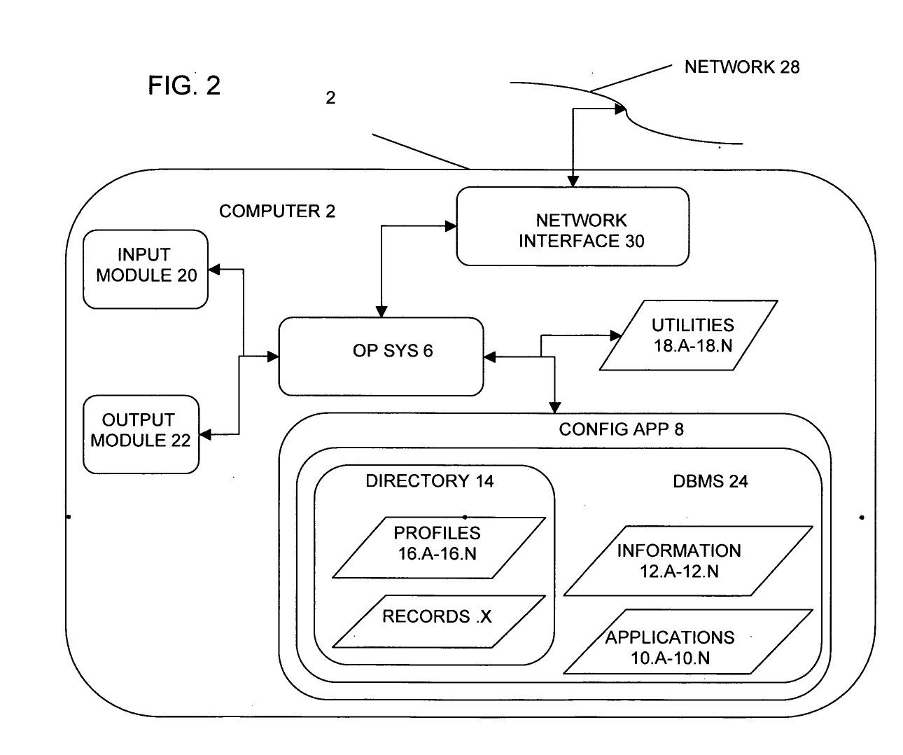

Referring now generally to the Figures and particularly to FIG. 2, FIG. 2 is a block diagram illustrating the exemplary computer 2 in accordance with certain preferred embodiments of method of the present invention. The op sys 6 is the fundamental software control program for computer 2, performing various functions including providing a user interface, managing the execution of one or more applications 10.A-10.N and utility software programs 18.A-18.N (hereafter, “utilities” 18.A-18.N), and controlling the input of data from and output of data to various input/output (I/O) devices 20 & 22. Op sys 6 can be any of a wide variety of conventional operating systems, such as any of the “WINDOWS” operating systems available from Microsoft Corporation of Redmond, Wash.

Application programs 10.A-10.N represent one or more of a wide variety of software application programs that can be executed on computer 2. Examples of such application programs include educational programs, reference programs, productivity programs (e.g., word processors, spreadsheets, databases), recreational programs, utility programs (e.g., communications programs), an email client, an address book, a computer security program, a web browser, a financial spreadsheet program, a software database, a software database management system, a graphics generation program, a video player, a video data editor, an audio data editor, and a calendar software. Application programs 10.A-10.N are pre-installed by the manufacturer or distributor of the computer 2 and enabled in response to a user command or permission as received by the computer 2. It is understood that one or more apps 10.A-10.N may comprise software code that directs the computer 2 to download a partial or entire software application, for example a remote app 10.Y, that is stored on a remote server 26 that is accessible via an electronics communications network 28 (hereafter, “network” 28). A network interface circuit 30 (hereafter, “network I/F”) of the computer 2 bi-directionally communicatively couples the computer 2 and the network 28.

The config app 8 may wholly or partially comprise, or be wholly or partially comprised within, a database management system 24 (hereafter, “DBMS” 24). The DBMS 24 might be or comprise, in singularity or combination, (1.) an object oriented database and an Object Oriented DBMS, (2.) an IBM DB2 Universal Database™ server (in Linux, UNIX®) marketed by IBM Corporation of Armonk, N.Y.; (3.) WINDOWS™ operating system environments marketed by Microsoft Corporation of Redmond, Wash.; (4.) a relational database, such as an SQL Server Yukon™ relational database software as marketed by Microsoft Corporation of Redmond, Wash.; (5.) an Oracle Database 11g™ relational database software as marketed by Oracle Corporation of Redwood Shores, Calif.; and/or (6.) multiple data sources to which the client query application sends queries.

The computer 2 and/or the remote server 26 may be may be selected from a group of suitable electronic devices known in the art, including (1.) a Nokia Model E61™ cellular telephone marketed by Nokia Corporation of Espoo Finland; (2.) a BLACKBERRY™ wireless personal digital assistant marketed by Research-in-Motion of Waterloo, Ontario, Canada; (3.) a VAIO FS8900™ notebook computer marketed by Sony Corporation of America, of New York City, N.Y.; (4.) POWERBOOK G4™ personal computer marketed by Apple Computer, Inc., of Cupertino, Calif.; (5.) an iPhone™ cellular telephone marketed by Apple Computer, Inc., of Cupertino, Calif.

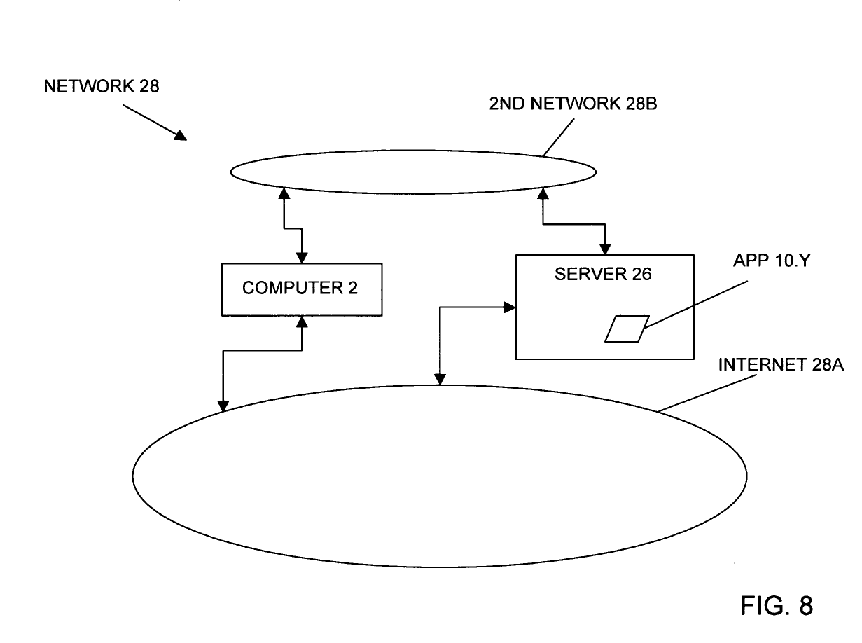

As illustrated in FIG. 8, the network 28 may be, comprise in whole or in part, or be comprised in whole or in part within, the Internet 28A and/or a second electronics communications network 28B. The second electronics network 28B may be or comprise, in whole or in part, an intranet, an extranet, an electronic computer network, a telephony system, a wireless telephony system, and/or a wireless electronics communications network, wherein the network I/F 30 is configured to enable electronic communications with the Internet 28A and/or the second electronics communications network 28B.

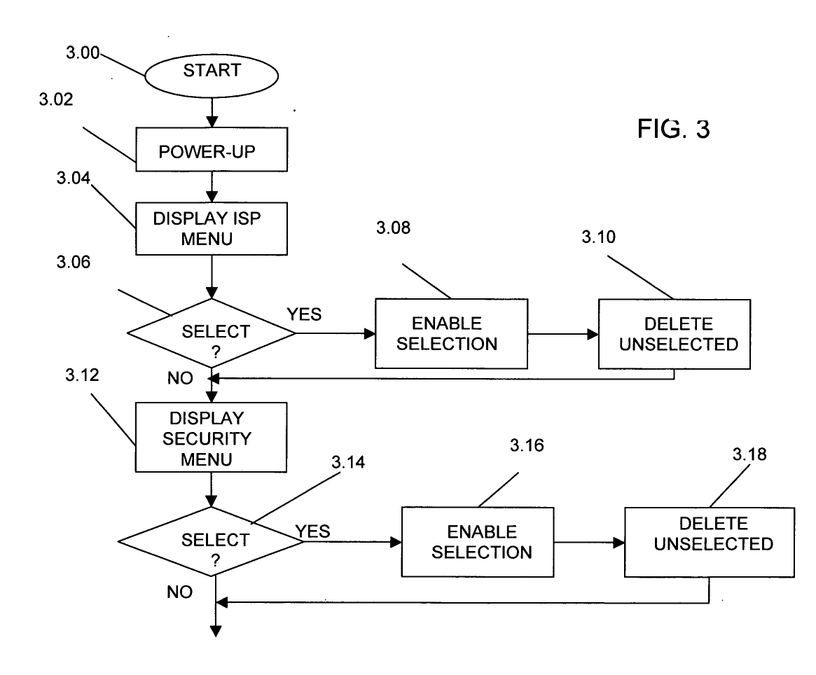

Referring now generally to the Figures and particularly to FIG. 3, FIG. 3 is a software flowchart of a process whereby the computer of FIGS. 2, 7 and 8 may implement certain aspects of the first alternate preferred embodiment of the method of the present invention.

Referring now generally to the Figures and particularly to FIG. 3, FIG. 3 is a software flowchart of a process whereby the computer 2 of FIGS. 2, 7 and 8 may implement certain aspects of the first alternate preferred embodiment of the method of the present invention. In step 3.02 of the first alternate preferred embodiment of the method of the present invention (hereafter, “first method”), the computer 2 is powered up and an ISP selection menu presenting Internet service providers is displayed via a video display screen 22A of a display device 22B of the output module 22. When a user selects an Internet service provider in step from 3.06 from the ISP selection menu, the computer 2 proceeds from step 3.06 to step 3.08 to enable the selection, i.e., execute an ISP software registration program. The user may select an ISP registration program in step 3.06 by means of a point and click selection device, e.g., a computer mouse 20A and/or a computer keyboard 20B of the input module 20. In optional step 3.10 ISP registration software program(s) not selected in step 3.06 are deleted from the computer 2.

In step 3.12 the computer 2 is powered up and a security software selection menu presenting security software choices is displayed via a video display screen 22A the output module 22. When a user selects an Internet service provider in step from 3.12 from the security software selection menu, the computer 2 proceeds from step 3.14 to step 3.16 to enable the selection, i.e., execute a security software program. The user may select a security software program in step 3.14 also by means of a point and click selection device, e.g., a computer mouse 20A and/or a computer keyboard 20B of the input module 20. In optional step 3.18 computer software program(s) not selected in step 3.14 are deleted from the computer 2.

It is understood that the ISP registration programs and the computer security programs respectively of steps 3.04 through 3.10 and steps 3.12-3.18 may be comprised within the apps 10.A-10.N. ISP registration programs include software that enables an account registration with (1.) America OnLine™ Internet service provider; (2.) Earthlink™ Internet service provider; and other suitable Internet Service provider registration software known in the art. Computer security software that may be referred to in the security software menu of step 3.12 may include (1.) McAfee VirusScan™ anti-virus software as marketed by McAfee Corporation of Santa Clara, Calif.; (2.) SpySweeper™ spy ware detector as marketed by Webroot Software, Inc. of Boulder Colo.; (3) and other suitable computer security software programs and products known in the art.

In the first version the computer 2 proceeds from either step 3.14 or step 3.18 to step 4.02.

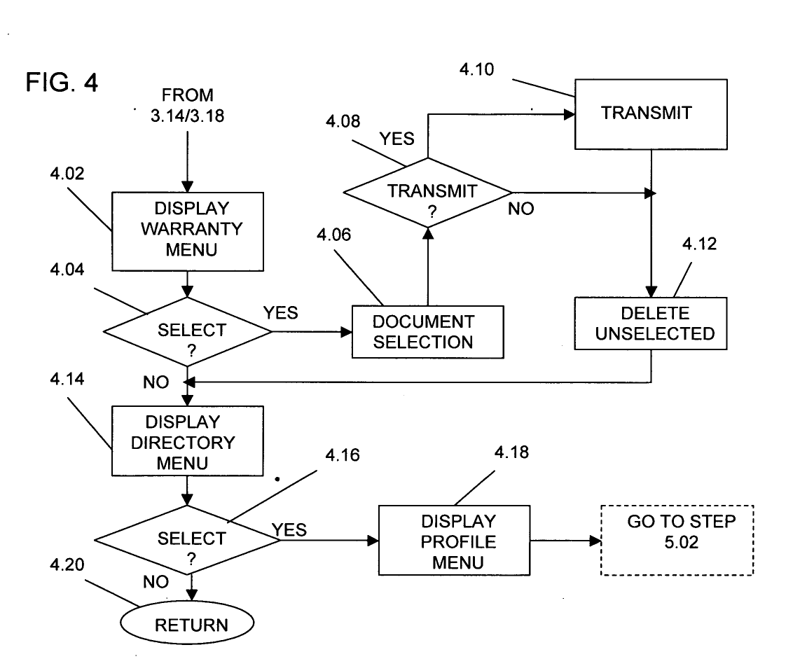

Referring now generally to the Figures and particularly to FIG. 4, Fig. is a software flowchart of a process whereby the computer 2 of FIGS. 2, 7 and 8 may implement certain other aspects of the first method. In step 4.02, the computer 2 a warranty selection menu presenting two or more warranty agreements is displayed via a video display screen 22A the output module 22. When the user selects a warranty form the warranty agreement selection menu, the computer 2 proceeds from step 4.04 to step 4.06 document and record the warranty selection. The user may select an warranty agreement in step 4.04 by means of a point and click selection device, e.g., the computer mouse 20A and/or the computer keyboard 20B of the input module 20. In optional step 4.08 the computer 2 determines whether the computer 2 is presently communicatively linked with the server 26 via the network 28. When the computer 2 determines that it is presently in communication with the server 26, the computer 2 transmits information regarding the instant warranty agreement of step 4.04 to the server 26 and via the network 28 in step 4.10. In optional step 4.12 one or more warranty agreements not selected in step 4.04 are deleted from the computer 2.

In step 4.14 the computer 2 is powered up and a profile selection menu presenting profile choices is displayed via a video display screen 22A the output module 22. When a user selects a profile 16.A-16.N in step from 4.16 from a directory selection menu MENU.DIR, the computer 2 proceeds from step 4.16 to step 4.18 to display a purchase selection menu MENU.PRO.

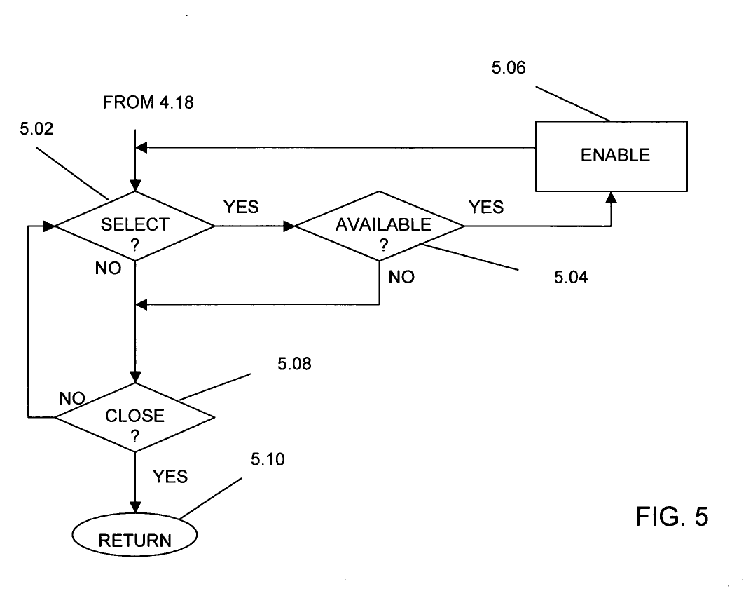

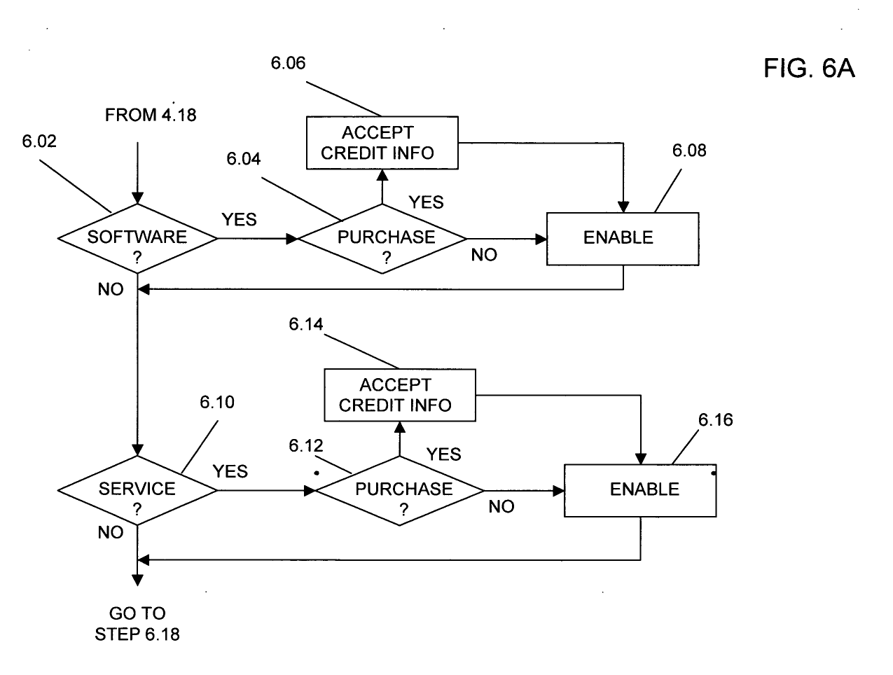

FIG. 5 is a software flowchart of a process whereby the computer 2 of FIGS. 2, 7 and 8 may implement certain yet other aspects of the first method. The computer 2 determines in step 5.02 whether the user has selected an option from the purchase selection menu MENU.PRO of step 4.18. When the computer 2 determines in step 5.02 that the user has selected an applications program 10.A-10.N from the purchase selection menu MENU.PRO, the computer 2 proceeds on to step 5.04 to determine if the applications program 10.A-10.N selected in step 5.02 is locally stored and available for installation and/or execution by the computer 2. When the computer 2 determines in step 5.04 that the applications program 10.A-10.N selected in step 5.02 is available for installation and/or execution, the computer 2 proceeds from step 5.04 to step 5.06 and to enable the user to run the selected program 10.A-10.N.

The computer 2 determines in step 5.08 whether the user wishes to close the purchase selection menu MENU.PRO of step 4.18 or to return to other computational process by proceeding onto step 5.10.

Referring now generally to the Figures and particularly to FIGS. 6A and 6B, FIGS. 6A and 6B are software flowcharts of a process whereby the computer 2 of FIGS. 2, 7 and 8 and the electronic communications network 28 of FIG. 8 may implement certain yet other aspects of the second alternate preferred embodiment of the method of the present invention (hereafter, “second method”).

The computer 2 determines in step 6.02 whether the user has selected an option to enable an applications program 10.A-10.N from the purchase selection menu MENU.PRO of step 4.18. When the computer 2 determines in step 6.02 that the user has selected an applications program 10.A-10.N from the purchase selection menu MENU.PRO, the computer 2 proceeds on to step 6.04 to determine if the applications program 10.A-10.N shall be purchased prior to enablement, I.e., installation or execution of the instant selected applications program 10.A-10.N. When purchase is required, the computer 2 accepts credit billing information in step 6.06 and the selected applications program 10.A-10.N is enabled for installation and/or execution by the computer 2 in step 6.08.

The computer 2 determines in step 6.10 whether the user has selected an option to enable an applications program 10.A-10.N that enables web service or other communications network based service from the purchase selection menu MENU.PRO of step 4.18. When the computer 2 determines in step 6.10 that the user has selected a service applications program 10.A-10.N from the purchase selection menu MENU.PRO, the computer 2 proceeds on to step 6.14 to determine if enablement of the instant network-based service applications program 10.A-10.N shall be purchased prior to enablement, i.e., installation or execution of the instant selected network based service applications program 10.A-10.N. When purchase is required, the computer 2 accepts credit-billing information in step 6.14 and the selected network-based service applications program 10.A-10.N is enabled for installation and/or execution by the computer 2 in step 6.16.

Referring now generally to the Figures and particularly to FIG. 6B, the computer 2 determines in step 6.18 whether the user has selected an option to purchase a hardware product from the purchase selection menu MENU.PRO of step 4.18. It is understood that the hardware product is not necessarily a computer related product, but may be another good that is typically physically delivered to a purchaser to fulfill a sale.

When the computer 2 determines in step 6.18 that the user has selected a hardware purchase option from the purchase selection menu MENU.PRO, the computer 2 proceeds on to step 6.20 to determine if the selected hardware item is offered at no charge or shall be purchased prior to shipment. When purchase before shipment of the hardware item is required, the computer 2 accepts credit-billing information in step 6.20. In addition, the computer 2 accepts delivery/mailing address information in step 6.24

The computer 2 determines in step 6.26 whether the computer 2 attempts to initiate a communications session with the remote server 26. When a communications session is successfully initiated in step 6.26, the computer 2 transmits ordering, billing and mailing/address information previously collected in steps 6.02 through 6.24 to the server 26 in step 6.38.

The computer 2 determines in step 6.30 whether any pending purchases previously requested by the user have been approved or disapproved by the server 26. In optional step 6.32 the enablements in the computer 2 of previously selected applications software programs 10.A-10.N, the purchase of which has been declined by the server 26, are disabled.

It is understood that in certain even other alternate preferred embodiments of the method of the present invention enablement of an applications program 10.A-10.N that requires purchase might not be permitted until the server 26 approves a purchase of the selected applications program 10.A-10.N.

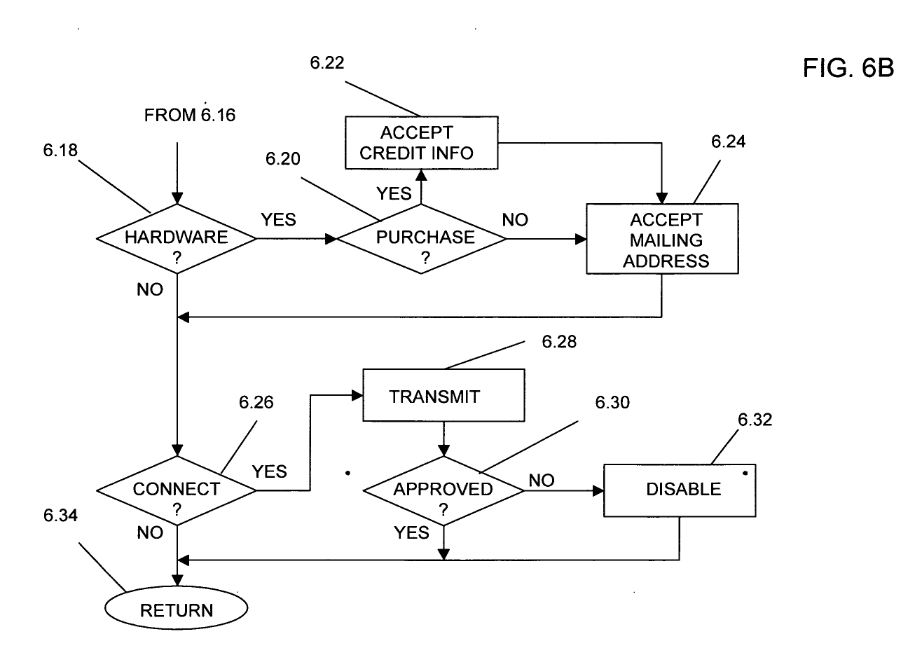

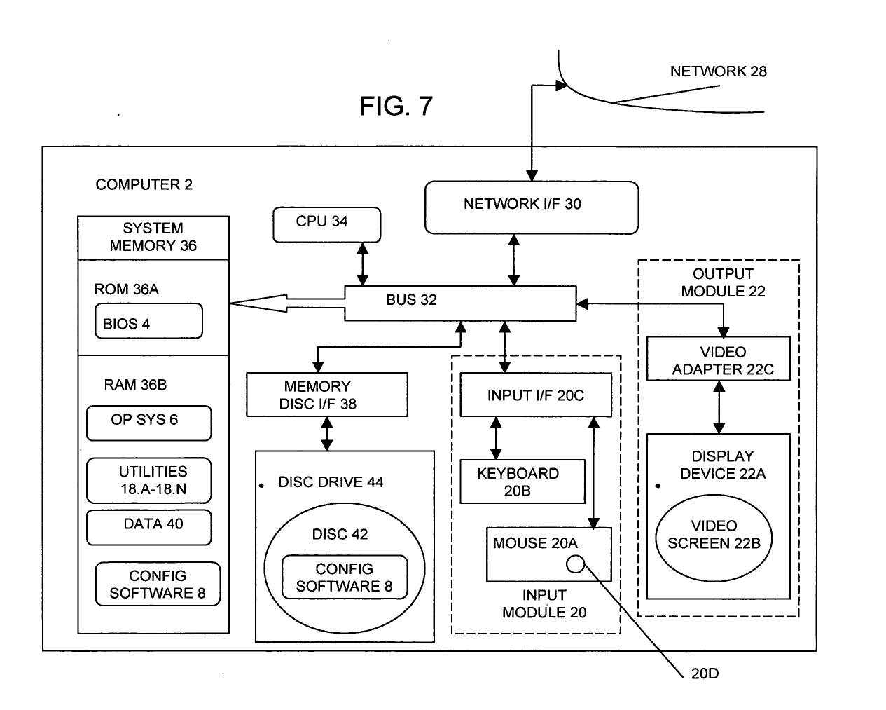

Referring now generally to the Figures and particularly to FIG. 7, FIG. 7 is a detailed schematic of the computer 2 of FIG. 2. It is understood that the server 26 may include one or more of the aspects and elements of the computer 2. The computer 2 includes an internal communications bus 32 that bi-directionally communicatively couples a central processing unit 34 (or CPU” 34), a system memory 36, a memory disc interface 38, the input module 20, the output module 22 and the network I/F 30. The BIOS 4 is stored in a read-only memory portion 36A of the system memory 36, and a random access memory portion 36B of the system memory 36 stores the OP sys 6, the plurality of utilities 18.A-18.N, a plurality of data 40, and the config software 8. It is understood that the config software 8 may be stored in whole or in part, or in duplication within the system memory 36 and within a memory disc 43 of a disc drive 44. The memory disc interface 38 enables the CPU 34 to retrieve software code of the config software 8 from memory disc 42. The memory disc 42 may be an optical or magnetic digital information storage medium, and the disc drive 44 and the memory disc interface 38 are configured to enable the CPU 34 to access information stored on the memory disc 42.

An input module interface 20C of the input module 20 is bi-directionally communicatively coupled with the bus 32 and is configured to (a.) accept outputs from the keyboard 20B and the mouse 20A, and (b.) translate and transmit the mouse and keyboard initiated signals to the bus 32 for interpretation by the CPU 34 as commands and information. A video adapter 22C of the output module 22 is bi-directionally communicatively coupled with the bus 32 and is configured to accept video data from the bus 32 and present images derived therefrom to the user by means of the video screen 22B of the display device 22A.

Referring now generally to the Figures and particularly to FIG. 8, FIG. 8 is a block diagram of the network 28 by which certain aspects of the first method, the second method, and certain other alternate preferred embodiments of the method of the present invention may be practiced. As disclosed previously herein, the network 28 may be, comprise in whole or in part, or be comprised in whole or in part within, the Internet 28A and/or a second electronics communications network 28B. The second electronics network 28B may be or comprise, in whole or in part, an intranet, an extranet, an electronic computer network, a telephony system, a wireless telephony system, and/or a wireless electronics communications network, wherein the network I/F 30 is configured to enable electronic communications with the Internet 28A and/or the second electronics communications network 28B.

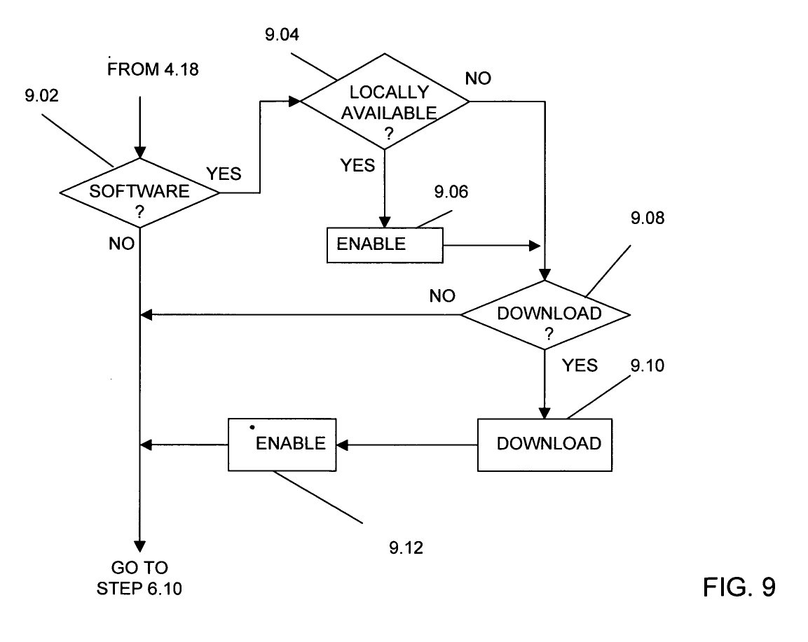

Referring now generally to the Figures and particularly to FIG. 9, FIG. 9 is a software flowchart of still other aspects of certain preferred alternate embodiments of the method of the present invention. The computer 2 determines in step 9.02 whether the user has selected an option to enable an applications program 10.A-10.N selected from the purchase selection menu MENU.PRO of step 4.18. When the computer 2 determines in step 9.02 that the user has selected an applications program 10.A-10.N from the purchase selection menu MENU.PRO, the computer 2 proceeds on to step 9.04 to determine if part or all of the applications program 10.A-10.N is locally stored and available on the computer 2. When the computer 2 determines in step 9.04 that part or all of the applications program 10.A-10.N of step 9.02 is at least partially locally stored and available, the computer 2 installs, runs and/or enables the instant applications program 10.A-10.N in step 9.06. The computer 2 proceeds from either step 9.04 or 9.06 to step 9.08 to determine whether part or all of the instant applications program 10.A-10.N is available for download from the remote server 26, or elsewhere in the network 28. When a download requirement and opportunity is determined in step 9.08, the computer 2 proceeds from step 9.08 to download all or part of the selected applications program 10.A-10.N in step 9.10. The downloaded software code of the applications program downloaded in step 9.10 is installed and made available for execution in step 9.12. It is understood that one or more applications programs 10.A-10.N may be partially stored locally and enabled in step 9.06, and partially downloaded in part in step 9.10, to enable a full installation and execution of the instant applications program 10.A-10.N in step 9.12.

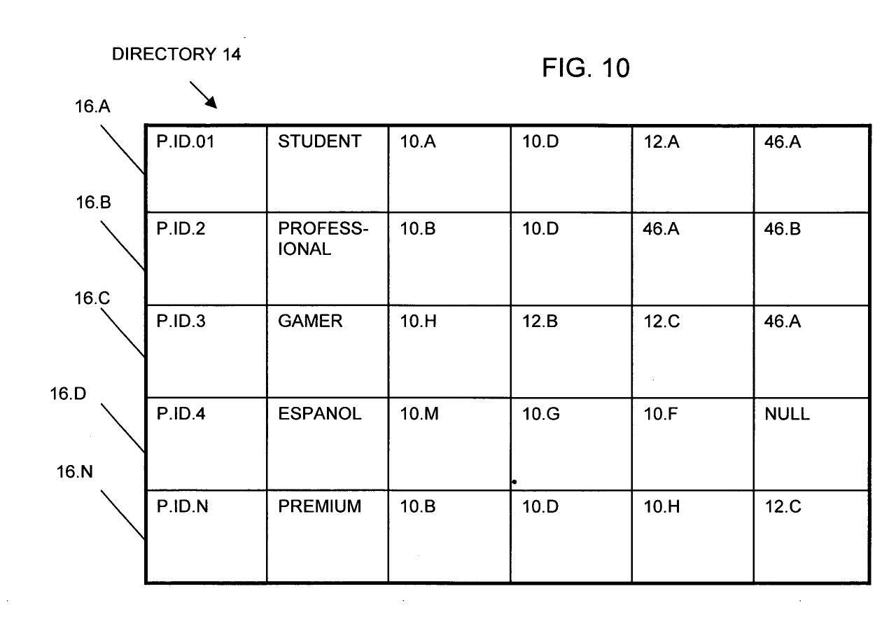

Referring now generally to the Figures and particularly to FIG. 10, FIG. 10 illustrates on aspect of the directory 14 wherein the profiles 16.A-16.N are stored. Each profile 16.A-16.N includes a profile identifier P.ID.01-P.ID.N that enables the computer 2 to distinguishes each profile 16.A-16.N as a unique profile 16.A-16.N. Each profile 16.A-16.N also includes a title, e.g., STUDENT for the first profile 16.A, PROFESSIONAL for the second profile 16.B, GAMER for the third profile 16.C, ESPANOL for the fourth profile 16.D, and PREMIUM for the nth profile 16.N. These titles are displayed on the profile screen, x as rendered by the output module 22.

Each profile 16.A-16.N further includes identifiers of applications programs 10.A-10.N, information 12.A-12.N and network service enabling software 46.A-46.N that are referenced by, and made available for use in learning about, purchasing or selecting products and services, when the comprising profile 16.A-16.N is (a.) selected by the user and (b.) visually represented by the output module 22.

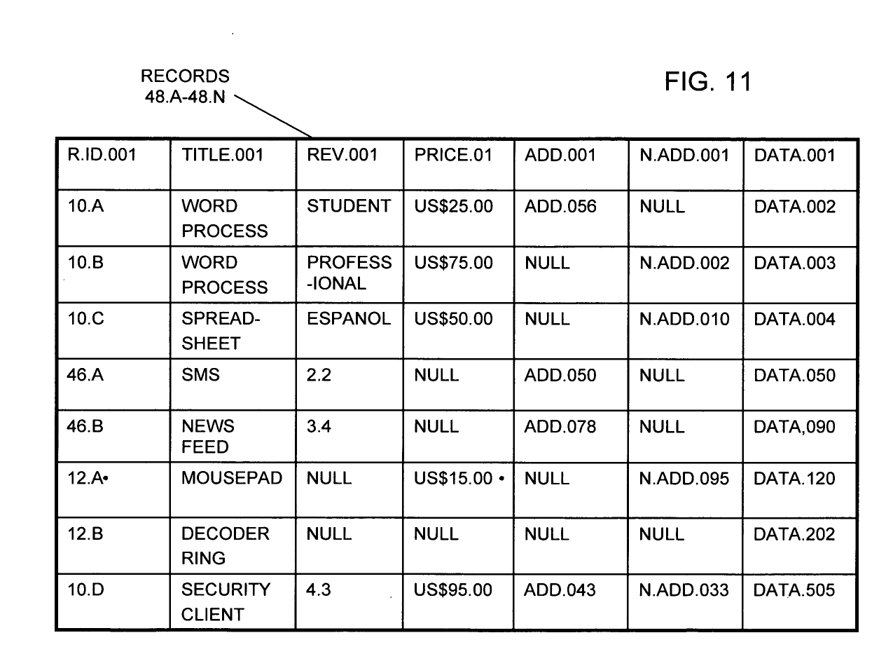

Referring now generally to the Figures and particularly to FIG. 11, FIG. 11 is a block diagram of software records 48.A-48.N that are accessed by the method of the present invention to locate and enable the display and/or execution of applications program 10.A-10.N, network service software 46.A-46.N, and product information 12.A-12.N. A plurality of record 48.A-48.N are individually represented as a row of data in FIG. 11, wherein each record 48.A-48.N includes an identifier, e.g., 10.A, 46.B, and 12.A and a title or product name, e.g., WORD PROCESS, NEWSFEED, and MOUSEPAD. Each record 48.A-48.N further includes a revision level, e.g., REV.001, STUDENT, and PROFESSIONAL. The price of a good or service may also be included in a record 48.A-48.N. A record 48.A-48.N may also include a local address of the host computer 2 where the software identified by the identifier may be read from, e.g., the first applications program 10.A may be read from a starting address of ADD.056 of the host computer's system memory 36, and a first service software 46. A may be read from a starting address of ADD.050 of the host computer's system memory 36. Additionally or alternatively, a record 48.A-48.N may contain a network address, e.g., N.ADD.002, N.ADD.010, from which some or all of a software program referenced in the instant record 46.A-46.N may be downloaded. For example, the SPREADSHEET software identified as the third applications program 10.C, and localized for Spanish speakers, may be downloaded from a network address of N.ADD.010 of the network 28. In addition, data stored for presentation to the user in reference to the software, product, or service identified in a same record 48.A-48.N may be included in a record 48.A-48.N and visually rendered by the output module 22. For example an information DATA.202 describing how to use the DECODER RING product referenced by the host computer 2 as a second product information 12.B may be stored, cross-referenced and identified in a same record 48.A-48.N.

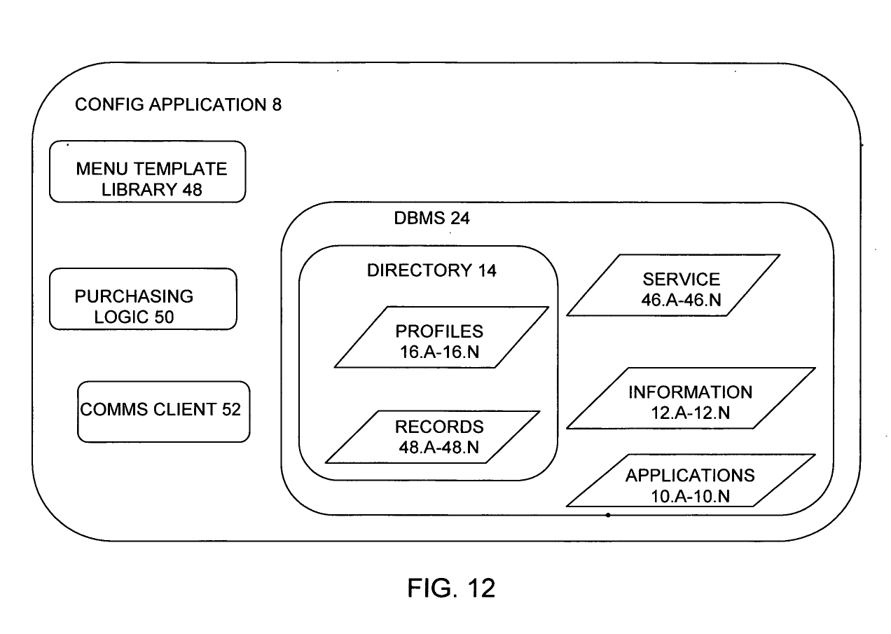

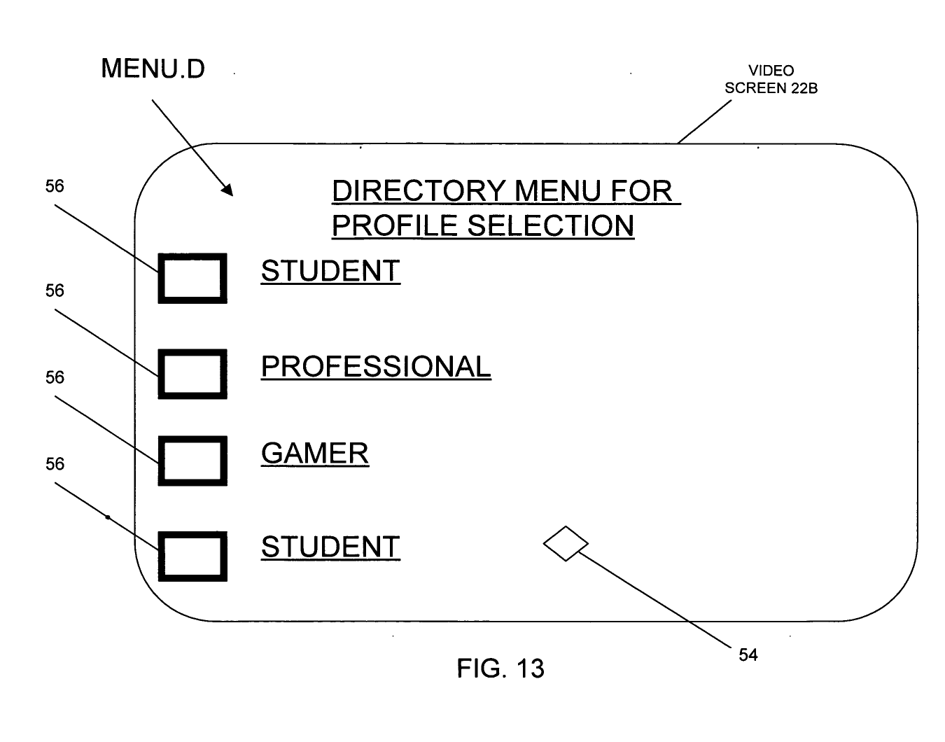

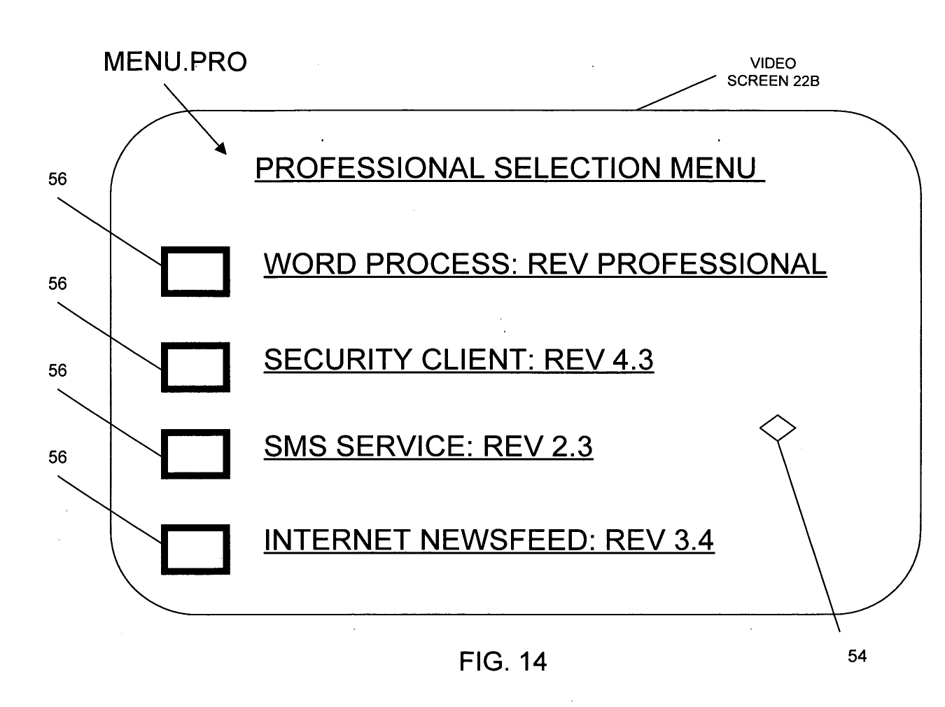

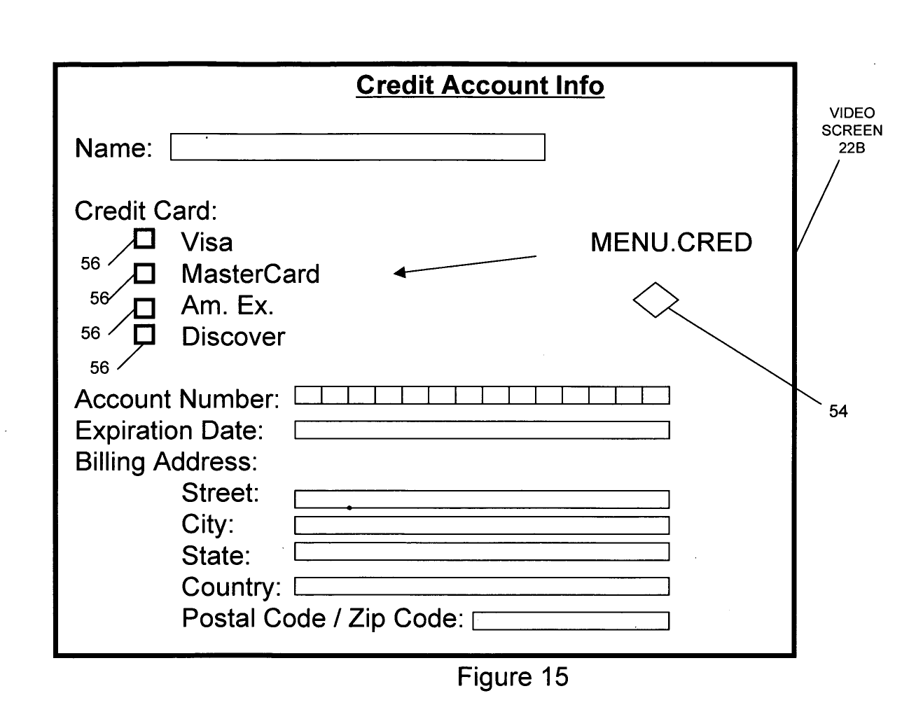

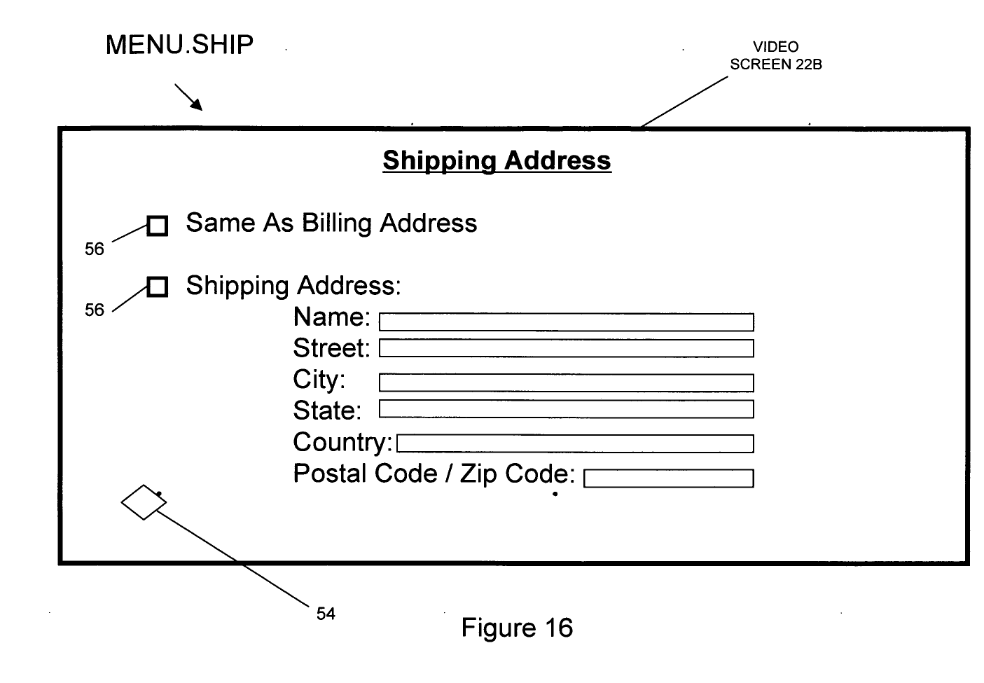

Referring now generally to the Figures and particularly to FIG. 12 is block diagram of the config application 8 of FIG. 2. The config application 8 includes a software menu template 48, a purchasing logic 50, a communications client 52, and the DBMS 24. The menu template 48 includes the software and encoded logic to enable the output module to visually display various selection menus, such as the directory menu MENU.DIR of FIG. 13, the profile selection menu MENU.PRO of FIG. 14, the ISP selection menu (not shown), the computer security software (not shown), and the credit purchase menu MENU.CRED of FIG. 15 and the shipping information menu MENUSHIP of FIG. 16. The purchasing logic 50 enables the formatting of messages for transmission to the server 26 that includes credit account information and shipping addresses. The communications software client 52 enables the transmission via the network I/F 30 and the network 28 to the server 26 of credit information and shipping information, as well as requests to download applications programs 10.A-10.N in whole or in part.

Referring now generally to the Figures and particularly to FIG. 13, FIG. 13 is a directory menu from which a user may select a profile 16.A-16.N. The first profile 16.A may be selected by the user by mean of applying the computer mouse 20A to (a.) position the cursor 54 into or over the selection icon 56 most proximate to a visual representation of a title of the desired profile, e.g., STUDENT, PROFESSIONAL; and (b.) then clicking a selection button 20D of the mouse 20A.

Referring now generally to the Figures and particularly to FIG. 14, FIG. 14 is a professional purchase selection menu MENU.PRO from which a plurality of products may be individually selected and purchased. The choices of products and services offered by the the “professional” selection menu MENU.PRO are derived from the second profile 16.B. A product or service may be selected for purchase, registration or use by the user by mean of applying the computer mouse 20A to (a.) position the cursor 54 into or over the selection icon 56 most proximate to a visual representation of a title of the desired product, e.g., WORD PROCESS, SMS SERVICE; and (b.) then clicking a selection button 20D of the mouse 20A.

Referring now generally to the Figures and particularly to FIG. 15, FIG. 15 is a credit information menu with which a user may provide credit account information to the computer 2. The user may use the keyboard to fill out the relevant data fields to provide a credit account number, an associated account holder name, an account expiry date thereof, and an associated billing address of the credit account. The user may identify a credit account type by (a.) using the mouse 20A to position the cursor 54 into or over the selection icon 56 most proximate to a visual representation of a credit account type; and (b.) then clicking a selection button 20D of the mouse 20A.

FIG. 16 is a shipping information menu with which a user may provide product mailing or other delivery instructions to the computer 2 by use of the computer mouse 20A and the computer keyboard 20B.

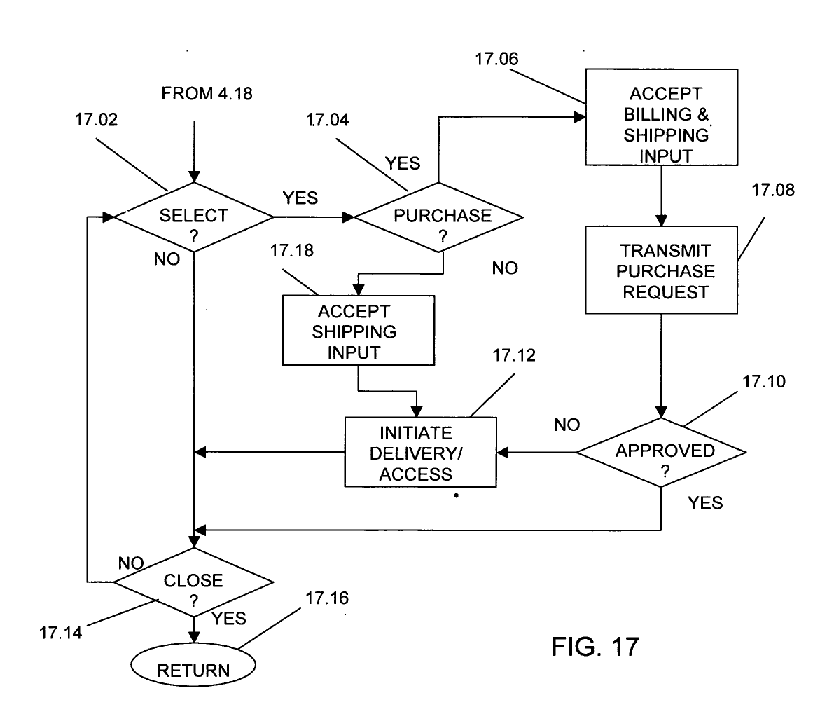

Referring now generally to the Figures and particularly to FIG. 17, FIG. 17 is a software flowchart of the computer executing still additional aspects of certain preferred alternate embodiments of the method of the present invention 7 in coordination with the server and the network of FIG. 2. In step 17.02 the computer 2 determines whether the user has selected a product or service from a selection, e.g., MENU.PRO or other purchase selection menu as derived from another profile 16.A-16.N. When the computer determines in step 17.02 that the user has selected a product or service, the computer 2 proceeds from step 17.02 to step 17.04 to determine whether the selected product or service shall be purchased. When the computer 2 determines in step 17.04 that the selected product or service shall be purchased, the computer proceeds from step 17.04 to step 17.06 and to request and receive billing and shipping information. In step 17.08 the computer 2 formats and transmits a purchase request to the server 26 via the network 28. The computer 2 determines in step 17.10 whether approval of the purchase request has been received. When the computer 2 determines in step 17.10 that approval of the purchase request has been received from the server 26 and via the network 28, the computer 2 proceeds from step 17.10 to step 17.12 to initiate a delivery or enablement process for the client. The execution of step 17.12 may include (a.) enabling access by the user to an applications program 10.A-10.N residing within the computer 2; (b.) initiating a download of a remotely stored applications program 10.Y; and/or (c.) initiating a postal service package mailing process.

When the computer 2 determines in step 17.10 that approval of the purchase request has not been received from the server 26 or via the network 28, the computer 2 does not initiate a delivery or enablement process of step 17.12, but rather proceeds from step 17.10 to step 17.14 to determine whether to either (a.) close the selection menu MENU.PRO and proceed onto other computational processing of step 17.16; or (b.) to return to step 17.02.

It is understood that a null value in a price data field of a record 48.A-48.N indicates that the product or service associated with the same record 48.A-48.N comprising said null price value does not require purchase, and that access to, or a delivery process of, may be initiated merely by selecting the instant product or service, in which cases the computers 2 proceeds directly from step 17.04 to step 17.18.

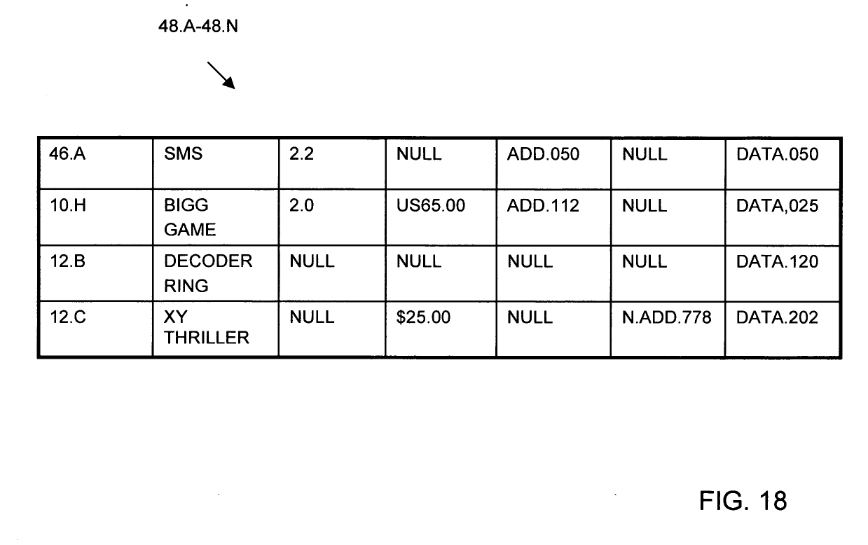

Referring now generally to the Figures and particularly FIG. 18, FIG. 18 is a schematic diagram of four records 48.A-48.N that are referenced by the third profile 16.C, or “gamer profile” 16.C. The gamer profile 16.C enables the computer 2 to offer, alternately for purchase, acquisition or subscription, (a.) a short next message service (as per 46.A), an electronic media product bearing a title of BIGG GAME (as per 10.H); a no-charge decoder ring (as per 12.B); and an electronic media product with software encoding of a movie feature entitled XY THRILLER (as per 12.C). The SMS service of 46.A may be subscribed to at no initial charge and by executing a registration client that is located at an address ADD.050 of the system memory 36 of the computer 2. The media of 10.H bearing a software game product entitled BIGG GAME may be purchased for $65.00 and by by executing a purchase request client that is located at an address ADD.112 of the system memory 36 of the computer 2. The DECODER RING product of 12.B may be acquired without payment by the user's accessing a data DATA.120 and mailing a letter in accordance with the instructions of the data DATA.120 via a postal service. The media of 12.C bearing the entertainment product entitled XY THRILLER may be purchased for $25.00 by the computer 2 initiating a communications session with a server 26 at network address N.ADD.778 of the network 26 and transmitting a purchase request with valid credit account and shipping information to the server 26.

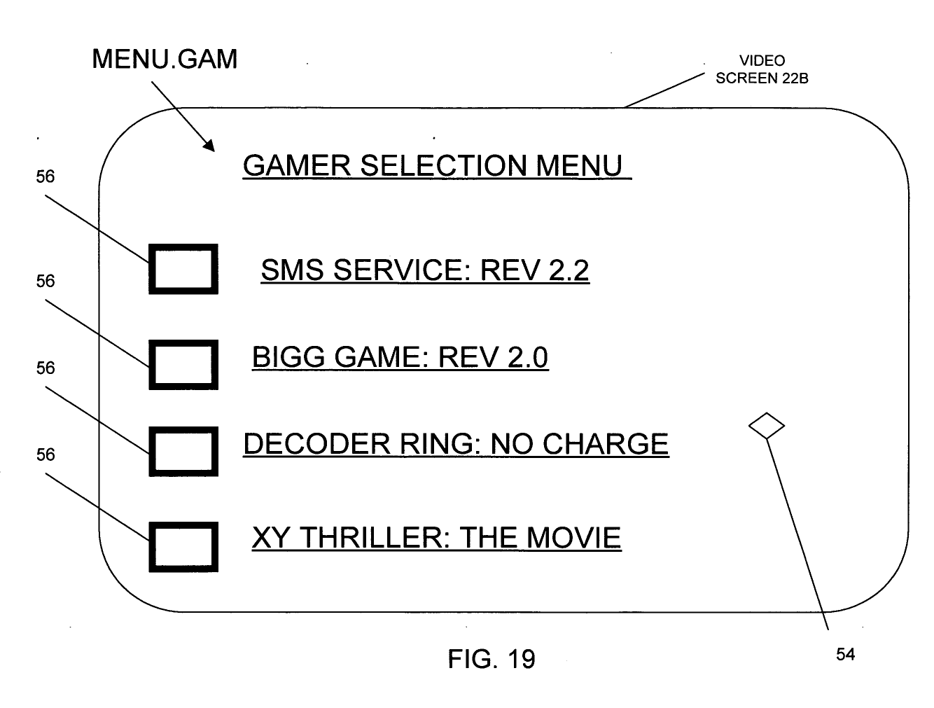

Referring now generally to the Figures and particularly to FIG. 19, FIG. 19 is a purchase gamer selection menu MENU.GAM from which a plurality of products may be individually selected and purchased. The choices of products and services offered by the gamer selection menu MENU.GAM are derived from the third profile 16.C. As described above, a product or service may be selected for purchase, registration or use by the user by mean of applying the computer mouse 20A to (a.) position the cursor 54 into or over the selection icon 56 most proximate to a visual representation of a title of the desired product, e.g., WORD PROCESS, SMS SERVICE; and (b.) then clicking a selection button 20D of the mouse 20A.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

What is claimed is:

1. In a computer system comprising a plurality of applications programs, a method of personalizing a software configuration of the computer system, the method comprising:
a. organizing a directory of applications programs, the directory including at least two profiles, each profile indicating a unique set of applications programs;
b. receiving from a user a selection of a user profile chosen from the at least two profiles; and
c. enabling access to each applications program indicated by the user profile to a user.

2. The method of claim 1, wherein at least one applications program is selected from the software group consisting of an email client, an address book, a computer security program, a web browser, a word processing program, a spreadsheet program, a software-database, a software database management system, a graphics generation program, a video player, a video data editor, an audio data editor, and a calendar software.

3. The method of claim 1, wherein at least one applications program is at least partially stored on a disc memory of the computer system.

4. The method of claim 1, wherein the computer system is bi-directionally communicatively coupled with a server and at least one applications program is available for download from the server.

5. The method of claim 1, wherein the computer system is bi-directionally communicatively coupled with a server and at least one applications program is configured to execute a download of software from the server.

6. The method of claim 5, wherein the server and the computer system are bi-directionally communicatively coupled via the Internet.

7. The method of claim 5, wherein the server and the computer system are bi-directionally communicatively coupled via a wireless communications network.

8. The method of claim 7, wherein the computer system is selected from the device group consisting of a cellular telephone, a wireless enabled personal digital assistant, and a wireless enabled personal computer.

9. The method of claim 1, wherein a plurality of communications applications are presented to the user and the user is enabled to select one or more communications programs for installation on the computer.

10. The method of claim 9, wherein the plurality of communications programs include a messaging utility selected from the utility software group consisting of an email client, a web-enabled email client, an instant messaging client, a text messaging client, and a short messaging telephony client.

11. The method of claim 1, wherein a plurality of security applications are presented to the user and the user is enabled to select one or more security programs for installation on the computer.

12. The method of claim 1, wherein at least two of warranty agreements are presented to the user and the user is enabled to accept at least one warranty agreement.

13. The method of claim 1, wherein a payment is required to enable user access to a first applications program and the computer is enabled to receive credit account payment information from a user to provide the payment.

14. In an electronics communications network comprising a computer system and a server, the electronics communications network storing a plurality of applications programs, a method of personalizing a software configuration of the computer system, the method comprising:
a. forming a directory of applications programs, the directory including at least two profiles, each profile indicating a unique set of applications programs;
b. presenting the at least two profiles to a user via the computer system;
c. receiving from a user a selection of a user profile chosen from the at least two profiles; and
d. enabling access to each applications program indicated by the user profile to the user.

15. The method of claim 14, wherein at least one applications program is selected from the software group consisting of an email client, an address book, a computer security program, a web browser, a word processing program, a financial spreadsheet program, a software database, a software database management system, a graphics generation program, a video player, a video data editor, an audio data editor, and a calendar software.

16. The method of claim 14, wherein at least one applications program is at least partially stored on a disc memory of the computer system.

17. The method of claim 14, wherein at least one applications program is available for download from the server.

18. The method of claim 14, wherein the electronics communications network comprises an extended network selected from the network group consisting of the Internet, an intranet, an extranet, an electronic computer network, a telephony system, a wireless telephony system, and a wireless electronics communications network.

19. The method of claim 14, wherein a payment is required to enable user access to a first applications program and the computer is enabled to receive credit account payment information from a user to provide the payment.

20. A computer system comprising:
a memory, the memory storing a plurality of applications programs;
a CPU, the CPU bi-directionally communicatively coupled with the memory and the CPU configured to execute each of the plurality of applications programs;
a directory of applications programs, the directory including at least two profiles, each profile indicating a unique set of applications programs;
means to receive a user a selection of a user profile chosen from the at least two profiles; and
c. means to enable access to each applications program indicated by the user profile to a user.
